(19) United States
(12) Patent Application Publication
(10) Pub. No.: US 2011/0239130 A1
(43) Pub. Date: Sep. 29, 2011

(54) Method, System and Computer Program Product for Conducting Formal Debates

(76) Inventor: Michael Lindley, Rancho Mirage, CA (US)

(21) Appl. No.: 12/854,889

(22) Filed: Aug. 11, 2010

Related U.S. Application Data
(60) Provisional application No. 61/318,140, filed on Mar. 26, 2010.

(51) Int. Cl. G06F 3/01; G06F 15/16

(52) U.S. Cl. 715/751

(57) ABSTRACT

A method, system and computer program product include a plurality of clients in communication with a network enabling bidirectional communication between the clients. Each of the clients includes a client application for enabling users to issue a request for engaging in a selected formal debate. Users are enabled to issue a request for finding opposition to engage in the selected formal debate. Users are enabled to select a topic for the formal debate. Users are enabled to upload at least one supporting media upload for supporting a first viewpoint of the selected topic. Users are enabled to upload at least one opposing media upload for rebutting the first viewpoint. Users are enabled to post ranking results from outside entities viewing the supporting media and the opposing media, thereby enabling users engaging in the selected formal debate to be ranked and a winner of the selected formal debate to be determined.

### CROSS-REFERENCE TO RELATED APPLICATIONS

The present Utility patent application claims priority benefit of the [U.S. provisional application for patent Ser. No. 61/318,140 filed on Mar. 26, 2010 entitled A System and Method for Online Interaction under 35 U.S.C. 119(e). The contents of this related provisional application are incorporated herein by reference for all purposes.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to globally networked interaction. More particularly, the invention relates to debating via a global network.

### BACKGROUND OF THE INVENTION

The development of the Internet and wireless protocol has led to a vast increase in human interaction via video conferencing, social networking, blogging, and other network applications. This has allowed people in various parts of the world to argue and debate over a range of chosen topics, however, on a very informal level.

Formal debate is a method of interactive and representational argument, and is a cornerstone of democracy, contributing to every democratic government ever constructed. Today, debate has taken many forms, including competitive debate, in which organized teams or individuals argue about a chosen topic.

In a formal debate, two or more teams or people argue in a predetermined format. At the conclusion of the debate, a winner is typically chosen, either by a panel of judges or the audience. The debate format or “forms” may include, by way of example only, Parliamentary, Mace, Public, Lincoln-Douglas and Classical.

Formal debates are typically conducted in-person or face-to-face, due to various rules specified by each format and the possibility of dishonesty. For example, a person or team may perform inappropriate research mid-debate or take more time than is allotted if they are not conducted in-person.

For informal debates, particularly those that occur on many topic-specific blogs, an individual's position or positions may get muddled due to the lack and structure and the number of individuals offering opinions on the chosen topic. Also, the chosen topic itself may evaporate due to the various subject changes that may occur during the discussion.

Conventional in-person/face-to-face formal debates can be very expensive, as debate participants or their sponsors must pay travel and lodging expenses. Travel requirements for face-to-face formal debates can also be very time consuming. Organizing and building a debate team for conventional face-to-face formal debates can also be very difficult as participants may be located in geographically different regions.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram depicting an exemplary client/server system which may be used by an exemplary web-enabled/networked embodiment of the present invention;

FIG. 2 illustrates an exemplary user interface screen which may be used by an exemplary web-enabled embodiment of the present invention for entering user identification information;

FIGS. 3A-B illustrates an exemplary user interface screen which may be used by an exemplary web-enabled embodiment of the present invention for creating a new team or for finding and selecting a team or teams with intent of joining;

FIG. 4 illustrates an exemplary user interface screen which may be used by an exemplary web-enabled embodiment of the present invention for requesting to join a team or teams;

FIG. 5 illustrates an exemplary user interface screen which may be used by an exemplary web-enabled embodiment of the present invention for granting or declining team membership to a requestor;

FIGS. 6A-B illustrates an exemplary user interface screen which may be used by an exemplary web-enabled embodiment of the present invention for creating a new debate or for finding and selecting a debate or debates with intent of joining;

FIG. 7 illustrates an exemplary user interface screen which may be used by an exemplary web-enabled embodiment of the present invention for displaying debate search results and for selecting to view or join a debate or debates;

FIG. 8 illustrates an exemplary user interface screen which may be used by an exemplary web-enabled embodiment of the present invention for displaying requests to join a debate or debates and for granting or declining access to join a debate or debates;

FIG. 9 illustrates an exemplary user interface screen which may be used by an exemplary web-enabled embodiment of the present invention for displaying requests to view a debate or debates and for granting or declining access to view a debate or debates;

FIG. 10 illustrates an exemplary user interface screen which may be used by an exemplary web-enabled embodiment of the present invention for displaying debate status and for selecting to view or begin participation in a debate;

FIG. 11 illustrates an exemplary user interface screen which may be used by an exemplary web-enabled embodiment of the present invention for participating in a debate;

FIG. 12 illustrates an exemplary user interface screen which may be used by an exemplary web-enabled embodiment of the present invention for voting for a winner of a debate; and

FIG. 13A-F illustrates operation of exemplary software which may be used by an exemplary web-enabled embodiment of the present invention.

Unless otherwise indicated illustrations in the figures are not necessarily drawn to scale.

### SUMMARY OF THE INVENTION

To achieve the forgoing and other aspects and in accordance with the purpose of the invention, a method, system and computer program product for conducting formal debates is presented.

In one embodiment a method executed by one or more computing processors includes steps for transmitting over a network, a user's request for engaging in a selected formal debate, steps for transmitting over the network, a further request for finding opposition to engage in the selected formal debate, steps for transmitting over the network, a selected topic for the selected formal debate, steps for uploading over the network, at least one supporting media upload for supporting a first viewpoint of the selected topic, steps for uploading over the network, at least one opposing media upload for rebutting the first viewpoint, and steps for transmitting over the network, ranking results, thereby enabling users engaging in the selected formal debate to be ranked and a winner of the selected formal debate to be determined. Another embodiment further includes steps for transmitting over the network, a further request for creating a team for engaging in the selected formal debate. Yet another embodiment further includes steps for transmitting over the network, a further request for joining the team.

In another embodiment a method executed by one or more computing processors includes the steps of transmitting over a network, from a client application being executed by one or more user clients, a user's request for engaging in a selected formal debate, wherein the selected formal debate comprises a standardized format for engaging in debate. The method transmits over the network, from the client application being executed by one or more user clients, a further request for finding opposition to engage in the selected formal debate. The method transmits over the network, from the client application being executed by one or more user clients, a selected topic for the selected formal debate. The method uploads over the network, from the client application being executed by one or more user clients, at least one supporting media upload for supporting a first viewpoint of the selected topic, where time for completing the supporting media upload being constrained to a first period of time. The method uploads over the network, from the client application being executed by one or more user clients, at least one opposing media upload for rebutting the first viewpoint, where time for completing the opposing media upload being constrained to a second period of time. The method transmits over the network, from the client application being executed by one or more user clients, ranking results from outside entities viewing the supporting media and the opposing media, where time for completing the transmitting of ranking results being constrained to a third period of time, thereby enabling users engaging in the selected formal debate to be ranked and a winner of the selected formal debate to be determined. Another embodiment further includes the step of transmitting over the network, from the client application being executed by one or more user clients, a further request for creating a team for engaging in the selected formal debate. Yet another embodiment further includes transmitting over the network, from the client application being executed by one or more user clients, a further request for joining the team. In still another embodiment the outside entities view the supporting media and the opposing media via one or more channels established by the users engaging in the formal debate. In another embodiment the one or more channels are linkable to or sharable by social networking websites. In yet another embodiment the first period of time comprises a fixed amount of time for researching the selected topic and preparing the supporting media. In still another embodiment the second period of time comprises a fixed amount of time for researching the selected topic, reviewing the supporting media and preparing the opposing media. In another embodiment the third period of time comprises a fixed amount of time for reviewing the supporting media, opposing media and preparing the ranking.

In another embodiment a system includes a plurality of clients, configurable for multimedia presentations, in communication with a network enabling bidirectional communication between the clients. Each of the clients includes a client application for enabling users to issue a request for engaging in a selected formal debate, wherein the selected formal debate comprises a standardized format for engaging in debate. Users are enabled to issue a request for finding opposition to engage in the selected formal debate. Users are enabled to select a topic for the formal debate. Users are enabled to upload at least one supporting media upload for supporting a first viewpoint of the selected topic, where time for completing the supporting media upload being constrained to a first period of time. Users are enabled to upload at least one opposing media upload for rebutting the first viewpoint, where time for completing the opposing media upload being constrained to a second period of time. Users are enabled to post ranking results from outside entities viewing the supporting media and the opposing media, where time for completing the posting being constrained to a third period of time, thereby enabling users engaging in the selected formal debate to be ranked and a winner of the selected formal debate to be determined. A communication gateway links the network to at least one server for at least storing media uploads and managing user registrations. In another embodiment the client application further enables users to issue a request for creating a team for engaging in the formal debate. In yet another embodiment the client application further enables users to issue a request for joining the team. In still another embodiment the outside entities view the supporting media and the opposing media via one or more channels established by the users engaging in the formal debate. In another embodiment the first period of time comprises a fixed amount of time for researching the selected topic and preparing the supporting media. In yet another embodiment the second period of time comprises a fixed amount of time for researching the selected topic, reviewing the supporting media and preparing the opposing media.

In another embodiment a computer program product residing on or being distributed across one or more computer readable mediums having a plurality of instructions stored thereon which, when executed by one or more associated processors, cause the one or more processors to transmit over a network a user's request for engaging in a selected formal debate, wherein the selected formal debate comprises a standardized format for engaging in debate. Instructions cause the one or more processors to transmit over the network a further request for finding opposition to engage in the selected formal debate. Instructions cause the one or more processors to transmit over the network a selected topic for the selected formal debate. Instructions cause the one or more processors to upload over the network at least one supporting media upload for supporting a first viewpoint of the selected topic, where time for completing the supporting media upload being constrained to a first period of time. Instructions cause the one or more processors to upload over the network at least one opposing media upload for rebutting the first viewpoint, where time for completing the opposing media upload being constrained to a second period of time. Instructions cause the one or more processors to transmit over the network ranking results from outside entities viewing the supporting media and the opposing media, where time for completing the transmitting of ranking results being constrained to a third period of time, thereby enabling users engaging in the selected formal debate to be ranked and a winner of the selected formal debate to be determined. Another embodiment further includes instructions for transmitting over the network a further request for creating a team for engaging in the selected formal debate. Yet another embodiment further includes instructions for transmitting over the network a further request for joining the team.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

A first embodiment of the present invention will be described which provides means and methods for providing online interaction between parties with interaction controlled by a predetermined set of rules. Non-limiting examples of predetermined rules include time limits, operational methods and media constraints. The interaction between parties may include any known media type. Non-limiting examples of media types include audios, videos, pictures, images and textual information. The media exchanged in the interaction between the parties may be original content created by the parties or may be created by other entities. Additional information may be attached or linked to the media for purposes of furthering the interaction between the parties. Non-limiting examples of additional information which may be attached or linked include videos, audios and text of arguments, comments, statements of clarification and rebuttals. Parties may share information related to the interaction between the parties with outside entities via a channel or channels which may be created by the parties. The information provided by the channels may be linked or shared with other social networking websites. Outside entities may rate the information provided by the channel or channels. The placement, display or priority of the information may then be determined by algorithms operating on the rating information provided by the outside entities. Algorithms for determination of the placement, display or priority of the information may include any known algorithm for determining placement, display or priority.

In other embodiments of the present invention, an open format may be provided where media may be uploaded for sharing and interaction with the online global community. The media may be constrained in some manner. Non-limiting examples of constraints which may be applied include time limit, type, category and topic of media. The media may be categorized and stored by topic and user.

In other embodiments of the present invention, a method for formal team debate may be provided. Furthermore, a method for creating and organizing teams may be provided. Debate teams may operate to debate with other debate teams on a global basis. Debate topics and formats may be selected by any user. Formats for debates may follow any known format for debate. Non-limiting examples of parameters which may be applied for debating include time limit of media, time limit for generating response and opportunity for rebuttal. Non-limiting examples of debate types which may be provided include Parliamentary, Mace, Public, Australasian, Policy, Classical, Extemporaneous, Lincoln-Douglas, Kari Popper, Impromptu and Paris. Debate related information may be stored and made available for viewing by registered users or made available to the online global community. Debates may be ranked by registered users for determining a winner. Algorithms for determination of a winner using ranking data may include any known algorithm for determining a winner.

In other embodiments, a registered user may operate to upload media related to a position for any topic. Other users may then operate to upload opposing media responses to the initial media. The initial registered user may then operate to upload media in response to the other users opposing media uploads. Non-limiting examples of constraints which may be applied include order of participation, time limit for the initial media, time limit for rebuttal media and time limit for making responses and rebuttals and time limit for debate.

In other embodiments, a registered user may operate to upload media related to a position for any topic. Other users may then operate to upload media opposing or supporting the argument of the initial media. The initial registered user may then operate to upload media in response to the other users opposing media uploads. Non-limiting examples of constraints which may be applied include order of participation, time limit for the initial media, time limit for the media of the responses, time limit for rebuttal media and time limit for making responses and rebuttals and time limit for debate.

In other embodiments, one registered user may operate to interact with one other registered user with the users choosing opposite viewpoints for discussion of a topic. Initially one user may upload media related to one viewpoint. The other user may then upload media in rebuttal related to the opposing viewpoint. Users may then take turns uploading rebuttal media to the other user's media upload. Users may have an equal number of opportunities for uploading media. Non-limiting examples of constraints which may be applied include order of participation, number uploads of media, time limit for the initial media, time limit for rebuttal media, time limit for making responses and rebuttals and time limit for debate.

In other embodiments, a method is provided for ensuring participants do not perform illicit research while participating in an interaction. Non-limiting examples of methods for preventing illicit research include monitoring video cameras, audio and location devices and also implementing hardware/software for sniffing illicit research activities via a communication network or networks. Opposing teams or individuals or moderators may monitor audio and video of participants in order to verify they do not perform illicit research. Opposing teams or individuals and/or moderators may also monitor location devices for verifying that participants do not travel to areas which may not be allowed as part of the interaction. Hardware/software may be used by opposing teams and/or moderators to monitor network traffic in order to verify participants do not access illicit outside information.

In other embodiments, a method of providing for reformatting debates for optimal viewing by others is provided. As such, the images may be reformatted for quality and ease of viewing. This may take place automatically via hardware and software.

Non-limiting examples of persons and entities which may use embodiments of the present invention include schools, colleges, universities, political organizations and debate clubs.

Non-limiting examples of mechanisms which a user seeking to operate an embodiment or embodiments of the present invention may be provided include creating an account, logging into an account, creating a channel, creating a new team, requesting to join a team or teams, searching for a team or teams, accepting or rejecting applicants for a team, requesting to join or view a debate, creating a new debate or debates, searching for a debate or debates, requesting to join a debate, accepting or rejecting applicants to a debate, accepting or rejecting applications to view a debate, uploading media, downloading media, viewing media and voting. Non-limiting examples of mechanisms for interfacing with embodiments of the present invention include Graphical User Interface (GUI), computer keypad, computer pointing device, mobile device display, mobile device keypad.

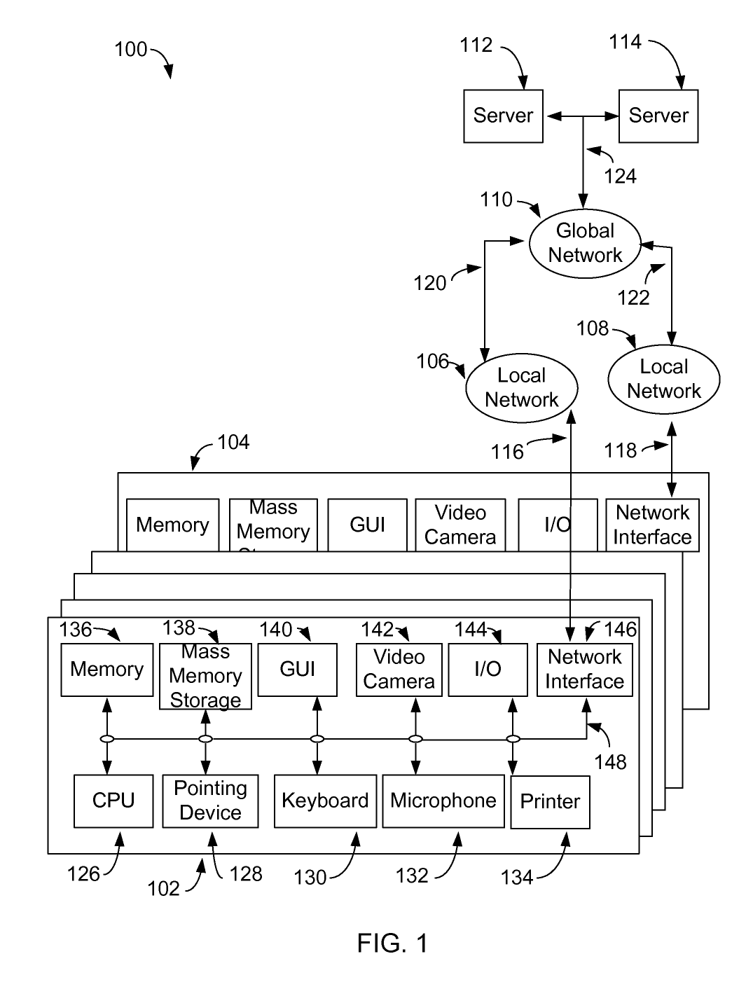

FIG. 1 is a block diagram depicting an exemplary client/server system which may be used by an exemplary web-enabled/networked embodiment of the present invention.

A communication system 100 includes a plethora of clients with a sampling of clients denoted as a client 102 and a client 104, a plethora of local networks with a sampling of networks denoted as a local network 106 and a local network 108, a global network 110 and a plethora of servers with a sampling of servers denoted as a server 112 and a server 114.

Client 102 may communicate bi-directionally with local network 106 via a communication channel 116. Client 104 may communicate bi-directionally with local network 108 via a communication channel 118. Local network 106 may communicate bi-directionally with global network 110 via a communication channel 120. Local network 108 may communicate bi-directionally with global network 110 via a communication channel 122. Global network 110 may communicate bi-directionally with server 112 and server 114 via a communication channel 124. Server 112 and server 114 may communicate bi-directionally with each other via communication channel 124. Furthermore, clients 102, 104, local networks 106, 108, global network 110 and servers 112, 114 may each communicate bi-directionally with each other. There are also generally one or more gateways (not shown) connecting the local networks 106 and the servers 112 to the global network 110.

In one embodiment, global network 110 may operate as the Internet. It will be understood by those skilled in the art that communication system 100 may take many different forms. Non-limiting examples of forms for communication system 100 include local area networks (LANs), wide area networks (WANs), wired telephone networks, wireless networks, or any other network supporting data communication between respective entities.

Clients 102 and 104 may take many different forms. Non-limiting examples of clients 102 and 104 include personal computers, personal digital assistants (PDAs), cellular phones and smartphones.

Client 102 includes a CPU 126, a pointing device 128, a keyboard 130, a microphone 132, a printer 134, a memory 136, a mass memory storage 138, a GUI 140, a video camera 142, an input/output interface 144 and a network interface 146. The client may also include removable media devices (not shown), such as CDs, DVDs, memory cards, etc.

CPU 126, pointing device 128, keyboard 130, microphone 132, printer 134, memory 136, mass memory storage 138, GUI 140, video camera 142, input/output interface 144 and network interface 146 may communicate in a unidirectional manner or a bi-directional manner with each other via a communication channel 148. Communication channel 148 may be configured as a single communication channel or a plethora of communication channels.

CPU 126 may be comprised of a single processor or multiple processors. CPU 126 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 136 is used typically to transfer data and instructions to CPU 126 in a bi-directional manner. Memory 136, as discussed previously, may include any suitable computer-readable media, intended for data storage, such as those described above excluding any wired or wireless transmissions unless specifically noted. Mass memory storage 138 may also be coupled bi-directionally to CPU 126 and provides additional data storage capacity and may include any of the computer-readable media described above. Mass memory storage 138 may be used to store programs, data and the like and is typically a secondary storage medium such as a hard disk. It will be appreciated that the information retained within mass memory storage 138, may, in appropriate cases, be incorporated in standard fashion as part of memory 136 as virtual memory.

CPU 126 may be coupled to GUI 140. GUI 140 enables a user to view the operation of computer operating system and software. CPU 126 may be coupled to pointing device 128. Non-limiting examples of pointing device 128 include computer mouse, trackball and touchpad. Pointing device 128 enables a user with the capability to maneuver a computer cursor about the viewing area of GUI 140 and select areas or features in the viewing area of GUI 140. CPU 126 may be coupled to keyboard 130. Keyboard 130 enables a user with the capability to input alphanumeric textual information to CPU 126. CPU 126 may be coupled to microphone 132. Microphone 132 enables audio produced by a user to be recorded, processed and communicated by CPU 126. CPU 126 may be connected to printer 134. Printer 134 enables a user with the capability to print information to a sheet of paper. CPU 126 may be connected to video camera 142. Video camera 142 enables video produced or captured by user to be recorded, processed and communicated by CPU 126.

CPU 126 may also be coupled to input/output interface 144 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 126 optionally may be coupled to network interface 146 which enables communication with an external device such as a database or a computer or telecommunications or internet network using an external connection shown generally as communication channel 116, which may be implemented as a hardwired or wireless communications link using suitable conventional technologies. With such a connection, CPU 126 might receive information from the network, or might output information to a network in the course of performing the method steps described in the teachings of the present invention.

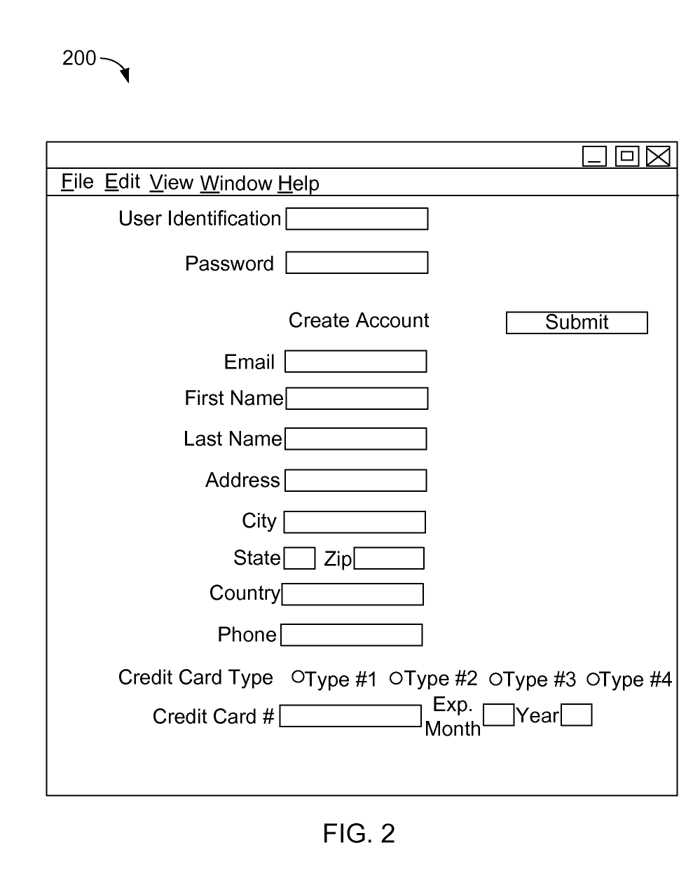

FIG. 2 illustrates an exemplary user interface screen 200 which may be used by an exemplary web-enabled embodiment of the present invention for entering user identification information.

User interface screen 200 may operate to allow a user to enter personal information, account information and other related information for creating or accessing an account. Non-limiting examples of information which may be entered include user identification, password, email address, first name, last name, address, city, state, zip code, country, telephone number, credit card type, credit card number credit card month and year of expiration. User interface screen 200 may operate to allow a user to control the operation of user interface screen 200 via menu and selection buttons. Non-limiting examples of menu and selection buttons include file, edit, view, window and help menu selections and minimize screen, expand-to-full-screen, close screen and submit selection.

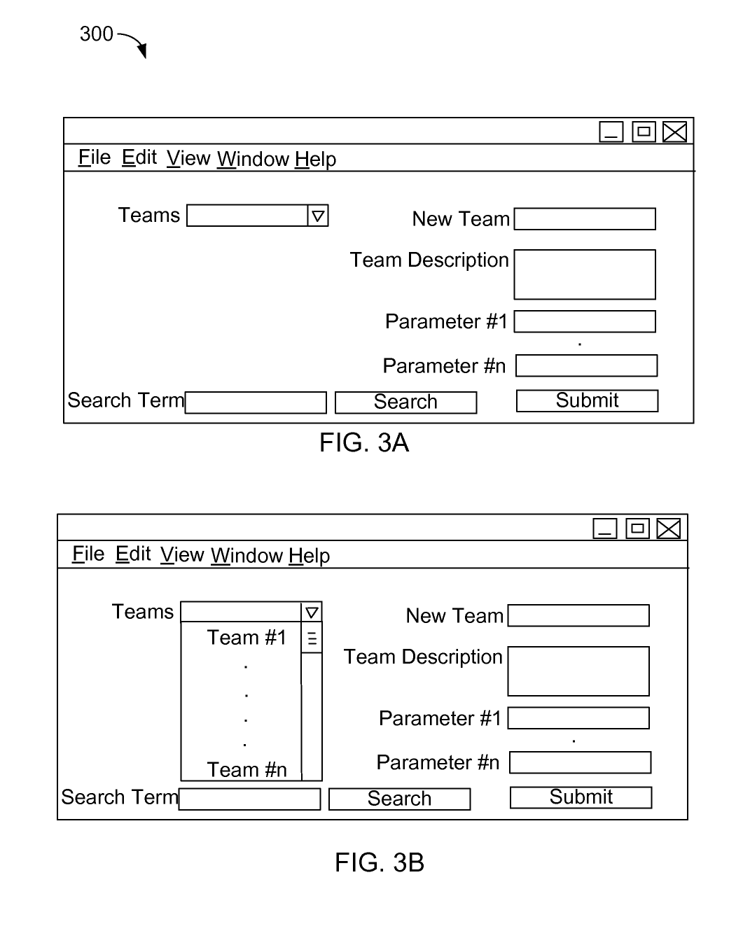

FIGS. 3A-B illustrates an exemplary user interface screen 300 which may be used by an exemplary web-enabled embodiment of the present invention for creating a new team or for finding and selecting a team or teams with intent of joining.

User interface 300 may operate to allow a user to create a new team, search for a team or request to join a team or teams. Non-limiting examples of information which may be entered or selected include team, new team name, new team description, team parameters and search terms. User interface screen 300 may operate to allow a user to control the operation of user interface screen 300 via menu and selection buttons. Non-limiting examples of menu and selection buttons include file, edit, view, window and help menu selections and minimize screen, expand-to-full-screen, close screen, search and submit selection.

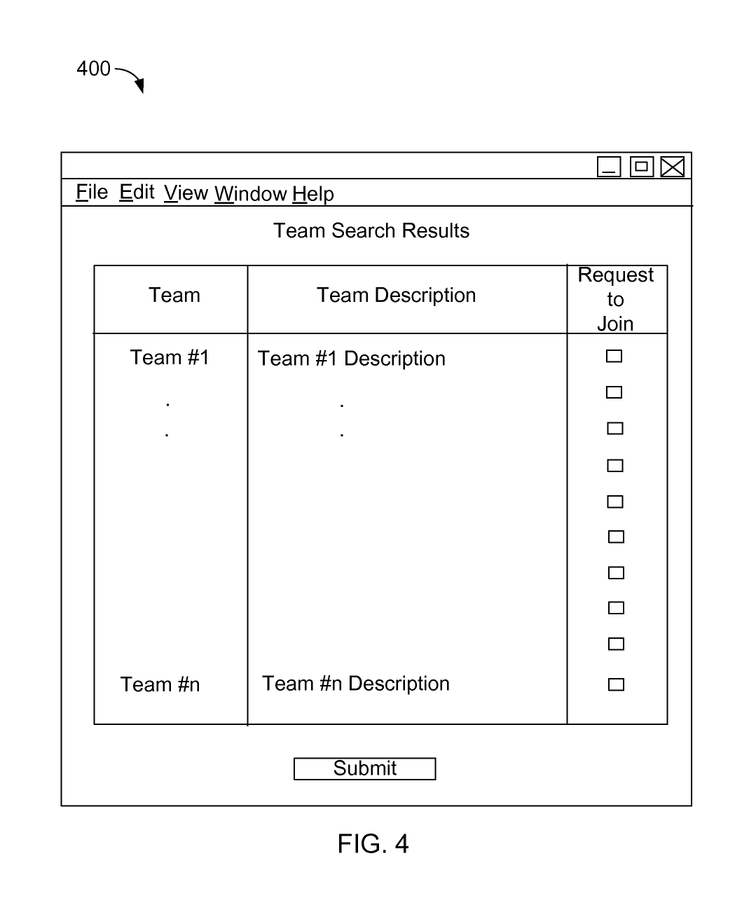

FIG. 4 illustrates an exemplary user interface screen 400 which may be used by an exemplary web-enabled embodiment of the present invention for requesting to join a team or teams.

User interface screen 400 may operate to allow a user to view a list of teams as a result of a search and to allow a user to request to join a team or teams. Non-limiting examples of information which may be displayed include team names and team descriptions and selection boxes for selecting to request to join a team or teams. User interface screen 400 may operate to allow a user to control the operation of user interface screen 400 via menu and selection buttons. Non-limiting examples of menu and selection buttons include file, edit, view, window and help menu selections and minimize screen, expand-to-full-screen, close screen and submit selection.

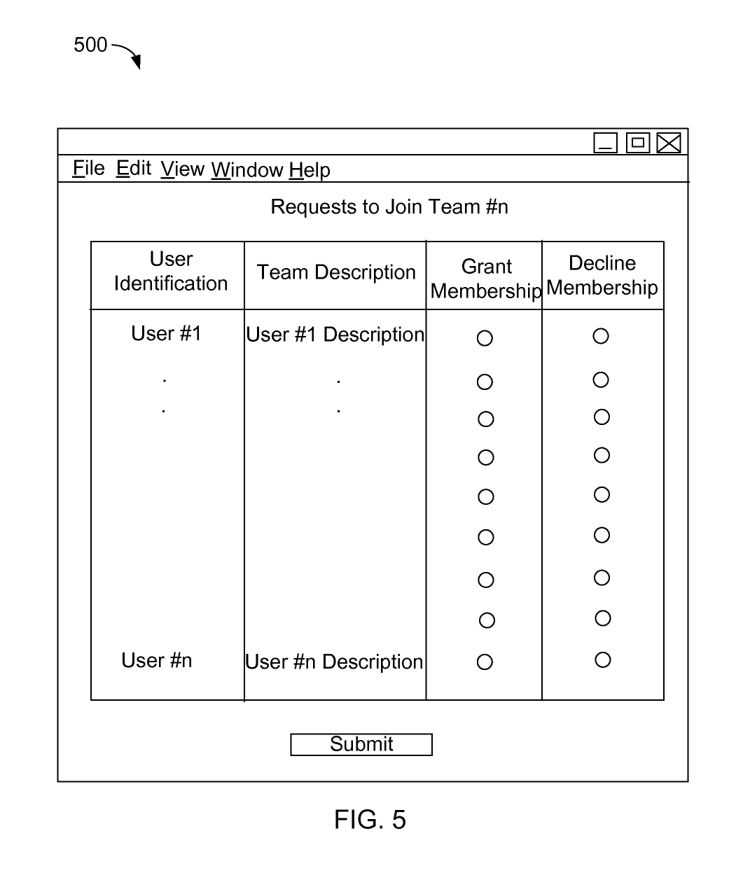

FIG. 5 illustrates an exemplary user interface screen 500 which may be used by an exemplary web-enabled embodiment of the present invention for granting or declining team membership to a requestor.

User interface 500 may operate to allow a user to grant or decline another user's request to join a team. Non-limiting examples of information which may be displayed include user identifications, user descriptions and radio selections for granting or declining requests to join a team. User interface screen 500 may operate to allow a user to control the operation of user interface screen 500 via menu and selection buttons. Non-limiting examples of menu and selection buttons include file, edit, view, window and help menu selections and minimize screen, expand-to-full-screen, close screen and submit selection.

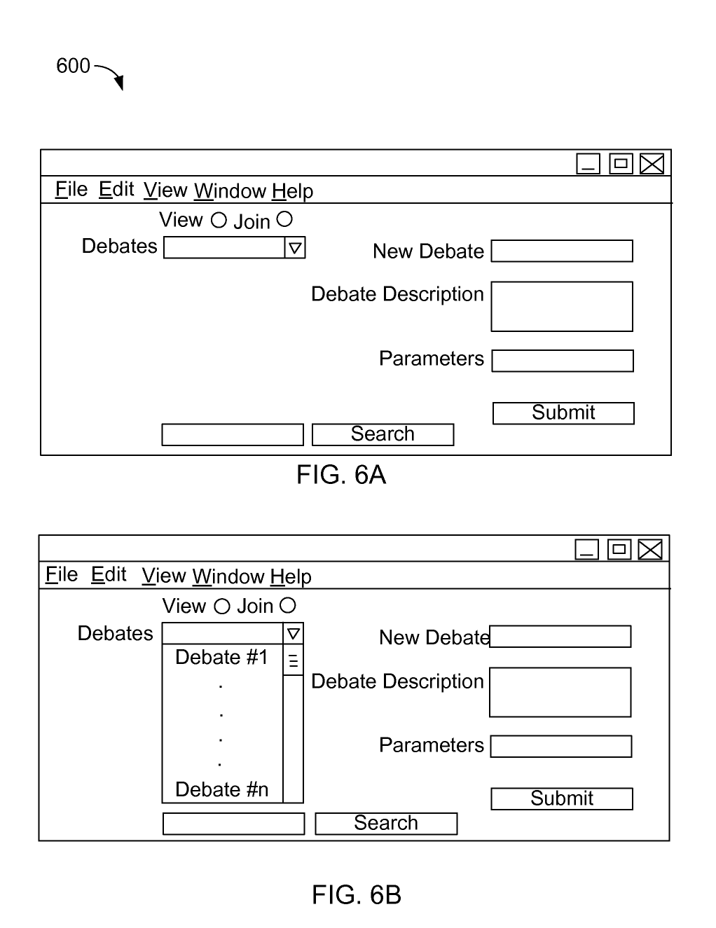

FIGS. 6A-B illustrates an exemplary user interface screen 600 which may be used by an exemplary web-enabled embodiment of the present invention for creating a new debate or for finding and selecting a debate or debates with intent of joining.

User interface 600 may operate to allow a user to create a new debate or find a debate for joining Non-limiting examples of information which may be entered or selected include debate, radio selection to view or join, new debate name, debate description, debate related parameters and search parameters. User interface screen 600 may operate to allow a user to control the operation of user interface screen 600 via menu and selection buttons. Non-limiting examples of menu and selection buttons include file, edit, view, window and help menu selections and minimize screen, expand-to-full-screen, close screen, search and submit selection.

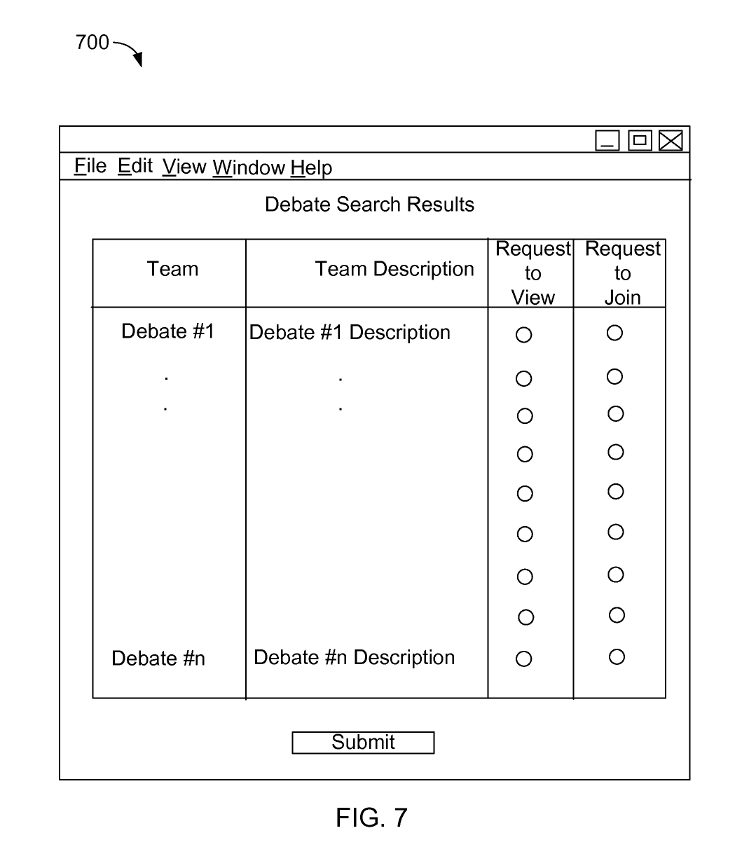

FIG. 7 illustrates an exemplary user interface screen 700 which may be used by an exemplary web-enabled embodiment of the present invention for displaying debate search results and for selecting to view or join a debate or debates.

User interface 700 may operate to allow a user to view information related to a search for a debate and select to view or join a debate or debates. Non-limiting examples of information which may be displayed include debate name, debate description and radio selections for requesting to view or join a debate. User interface screen 700 may operate to allow a user to control the operation of user interface screen 700 via menu and selection buttons. Non-limiting examples of menu and selection buttons include file, edit, view, window and help menu selections and minimize screen, expand-to-full-screen, close screen and submit selection.

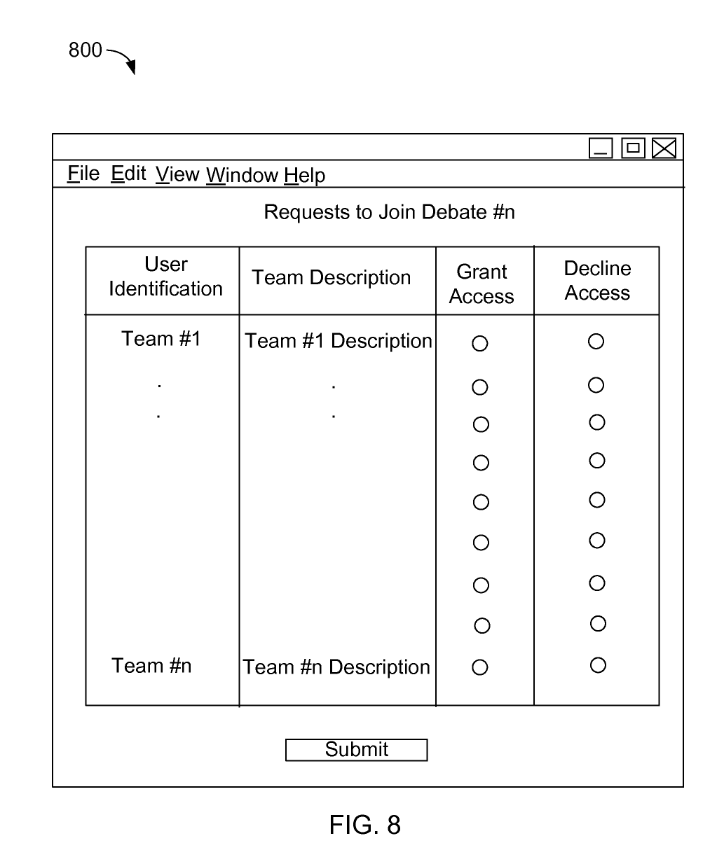

FIG. 8 illustrates an exemplary user interface screen 800 which may be used by an exemplary web-enabled embodiment of the present invention for displaying requests to join a debate or debates and for granting or declining access to join a debate or debates.

User interface screen 800 may operate to allow a user to view requests for joining a debate and allow user to grant or decline access to a debate by a requesting team or teams. Non-limiting examples of information which may be displayed include team name, team description and radio selections for selecting to grant or decline a team or teams access to a debate. User interface screen 800 may operate to allow a user to control the operation of user interface screen 800 via menu and selection buttons. Non-limiting examples of menu and selection buttons include file, edit, view, window and help menu selections and minimize screen, expand-to-full-screen, close screen and submit selection.

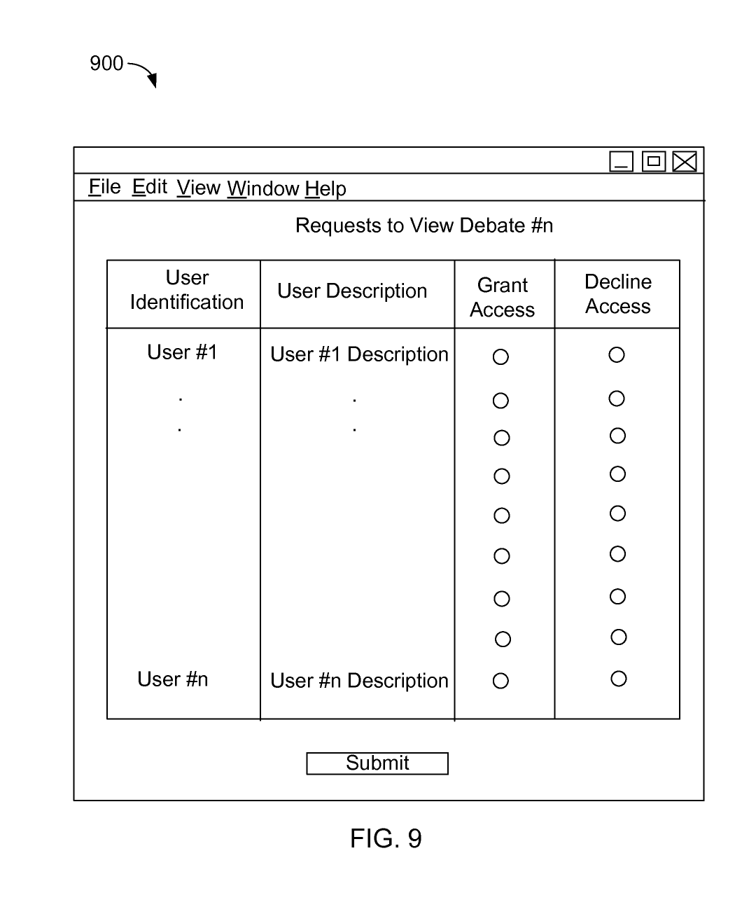

FIG. 9 illustrates an exemplary user interface screen 900 which may be used by an exemplary web-enabled embodiment of the present invention for displaying requests to view a debate or debates and for granting or declining access to view a debate or debates.

User interface screen 900 may operate to allow a user to view requests for viewing a debate and allow user to grant or decline access to view debate by a requesting team or teams. Non-limiting examples of information which may be displayed include team name, team description and radio selections for selecting to grant or decline a team or teams access to view a debate. User interface screen 900 may operate to allow a user to control the operation of user interface screen 900 via menu and selection buttons. Non-limiting examples of menu and selection buttons include file, edit, view, window and help menu selections and minimize screen, expand-to-full-screen, close screen and submit selection.

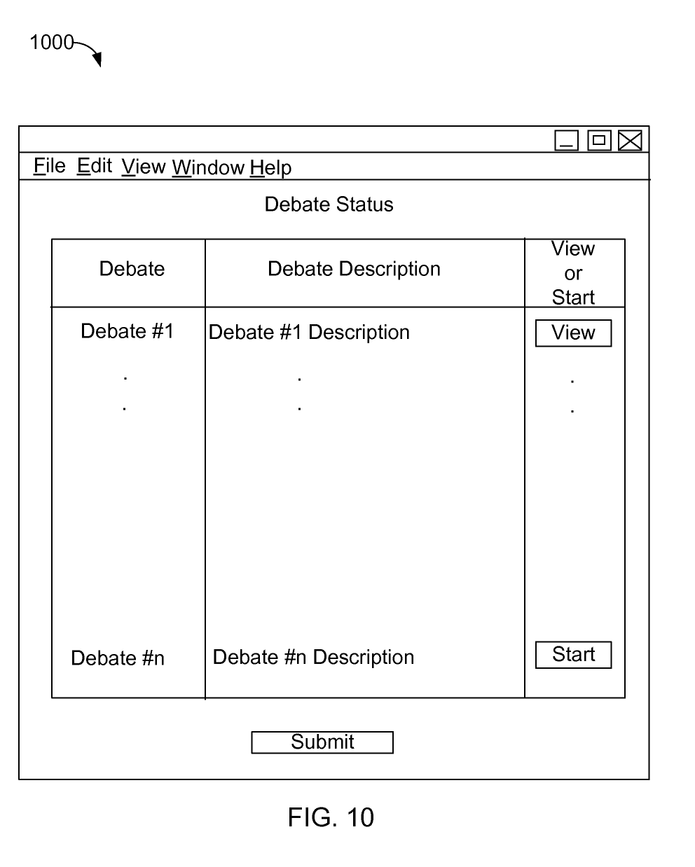

FIG. 10 illustrates an exemplary user interface screen 1000 which may be used by an exemplary web-enabled embodiment of the present invention for displaying debate status and for selecting to view or begin participation in a debate.

User interface screen 1000 may operate to allow a user to view debate status. Non-limiting examples of information which may be displayed include debate name, debate description and selection button for initiating viewing or participation in a debate. User interface screen 1000 may operate to allow a user to control the operation of user interface screen 1000 via menu and selection buttons. Non-limiting examples of menu and selection buttons include file, edit, view, window and help menu selections and minimize screen, expand-to-full-screen, close screen and submit selection.

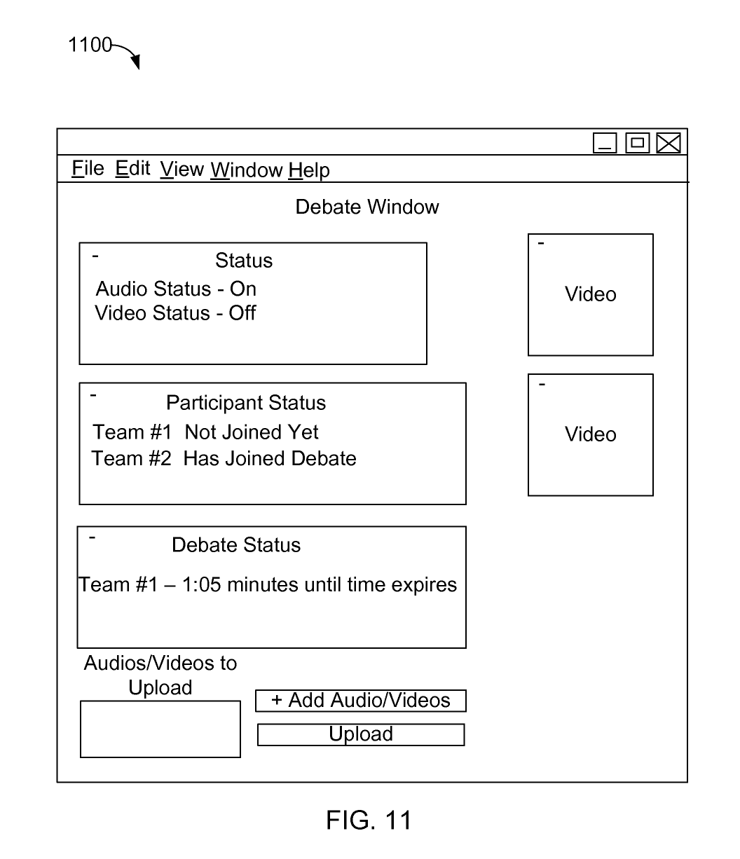

FIG. 11 illustrates an exemplary user interface screen 1100 which may be used by an exemplary web-enabled embodiment of the present invention for participating in a debate.

User interface screen 1100 may operate to allow a user to participate in a debate. Non-limiting examples of information which may be displayed to user include status, audio status, video status, video, participant status, debate status and entry locations for uploading audio and video. User interface screen 1100 may operate to allow a user to control the operation of user interface screen 1100 via menu and selection buttons. Non-limiting examples of menu and selection buttons include file, edit, view, window and help menu selections and minimize screen, expand-to-full-screen, close screen and upload selection.

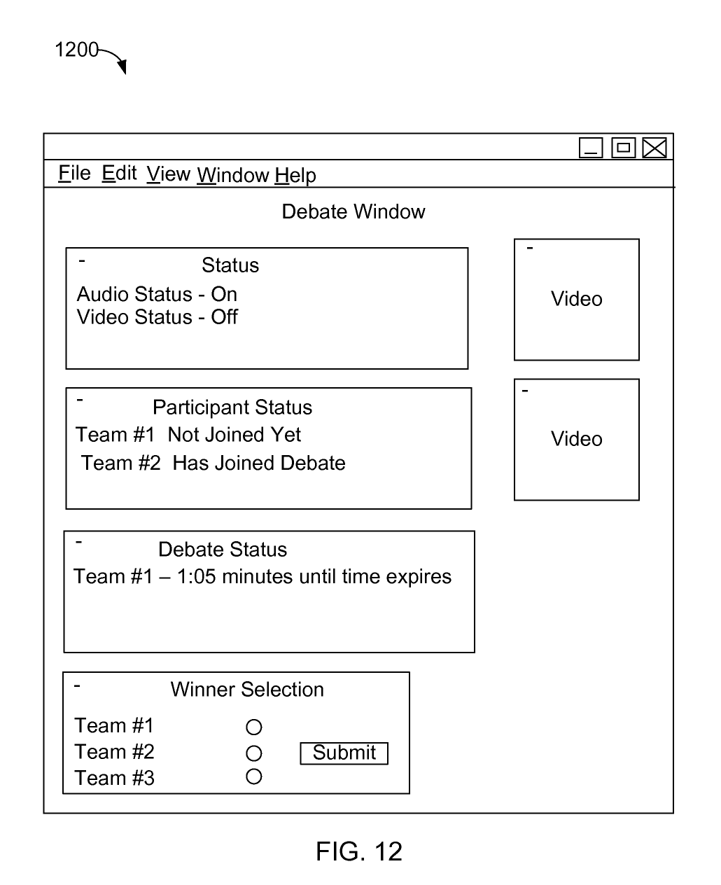

FIG. 12 illustrates an exemplary user interface screen 1200 which may be used by an exemplary web-enabled embodiment of the present invention for voting for a winner of a debate.

User interface screen 1200 may operate to allow a user to vote for a winner of a debate. Non-limiting examples of information which may be displayed include audio status, video status, participant status, debate status, video, team participants and radio selections for selecting a winning team. User interface screen 1200 may operate to allow a user to control the operation of user interface screen 1200 via menu and selection buttons. Non-limiting examples of menu and selection buttons include file, edit, view, window and help menu selections and minimize screen, expand-to-full-screen, close screen and submit selection.

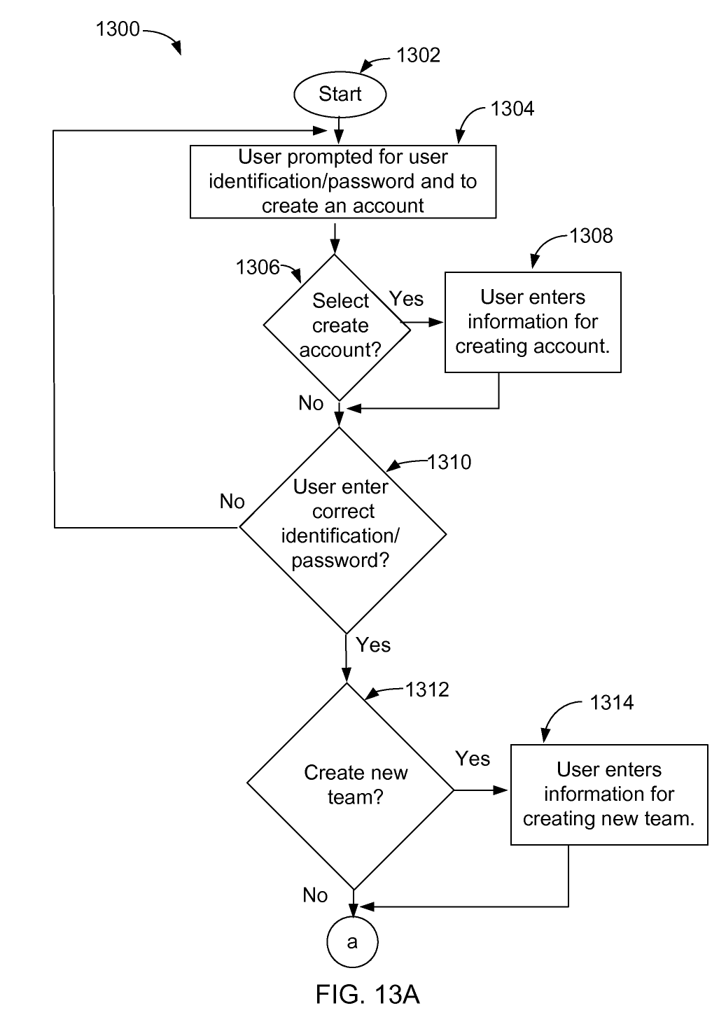

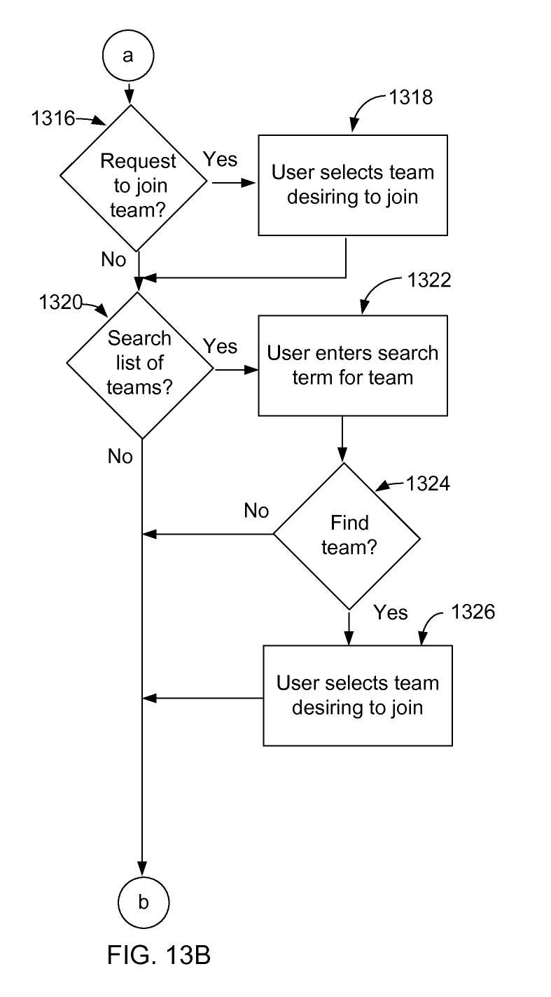

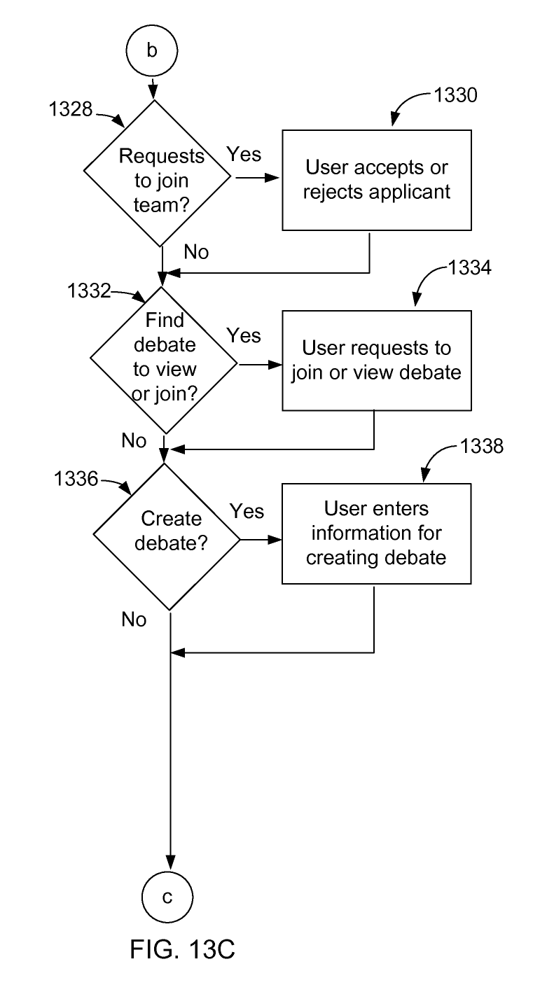

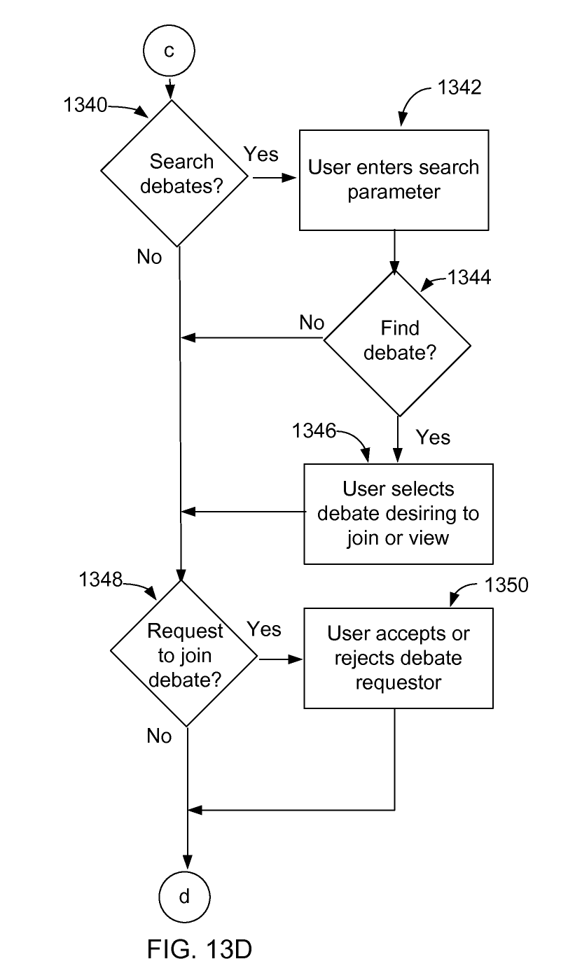

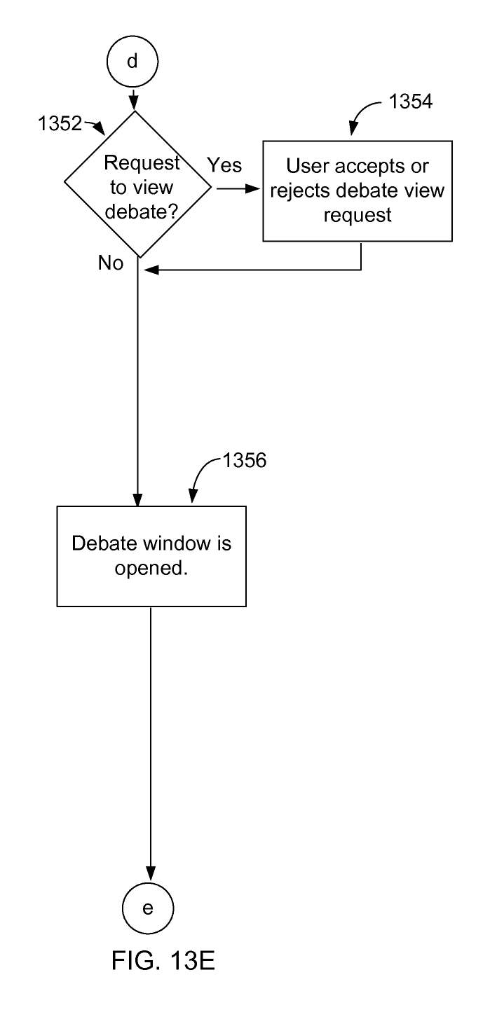

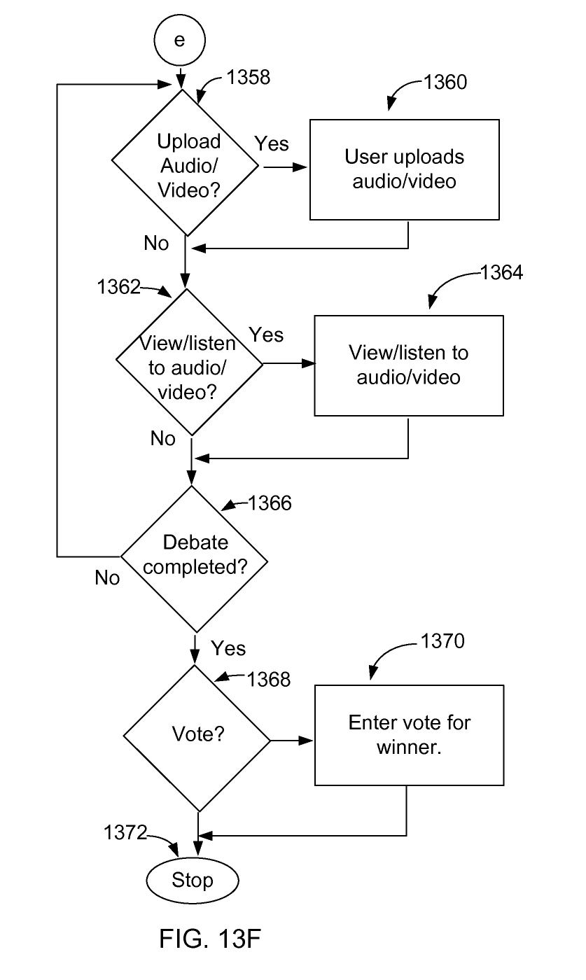

FIGS. 13A-F illustrates operation of exemplary software which may be used by an exemplary web-enabled embodiment of the present invention.

FIGS. 13A-F is a flow chart 1300 illustrating an exemplary process for the execution of software in accordance with an embodiment of the present invention. In the present embodiment, the process initiates in a step 1302 (FIG. 13A). The software may be operable for instruction execution and storage of information on server 112 (FIG. 1) and/or server 114 (FIG. 1). In a step 1304, user may be prompted on GUI 140 (FIG. 1) of client 102 (FIG. 1) to enter a user identification and password and may also be prompted to create an account (FIG. 2). Non-limiting examples of GUIs include computer monitor, cell phone display and television. The information which may be displayed to user via GUI 140 (FIG. 1) may initiate at server 112 (FIG. 1) and/or server 114 (FIG. 1) and may be transmitted to global network 110 (FIG. 1) via communication channel 124 (FIG. 1). The information may then transferred from global network 110 (FIG. 1) to local network 106 (FIG. 1) via communication channel 120 (FIG. 1). The information may then transferred from local network 106 (FIG. 1) to network interface 146 (FIG. 1) via communication channel 116 (FIG. 1). The information may then transferred from network interface 146 (FIG. 1) to GUI 140 (FIG. 1). The information may be transferred from network interface 146 (FIG. 1) to GUI 140 (FIG. 1) directly or with assistance from CPU 126. Information may be transferred from client 102 (FIG. 1) to server 112 (FIG. 1) and/or server 114 (FIG. 1) in the reverse process as previously discussed. If user has a prior established account, then the user may enter an identification and password. In a step 1306 (FIG. 13A), it may be determined if user selects to create an account. If user selects to create an account, then in a step 1308 user may enter information for creating an account. Non-limiting examples of information for creating an account include user identification, password, first name, middle name, last name, street address, city, state, zip code, country, phone number, fax number, email address, security questions, credit card type, credit card number, credit card expiration month, credit card expiration year, credit card security code. Non-limiting examples of devices user may enter information include computer keyboard, computer pointing device, mobile communication device keypad and cellular telephone keypad. Non-limiting examples of devices user may enter information for this embodiment include keyboard 130 (FIG. 1) and pointing device 128 (FIG. 1). In a step 1310 (FIG. 13A), software may determine if user has entered the correct identification and password information. If user enters incorrect user identification and password information, operation of software may return to step 1304. In a step 1312, it may be determined if a user seeks to create a new team. If user seeks to create a new team, then in a step 1314 user may enter information for creating a new team (FIGS. 3A-B). Non-limiting examples of information which may be entered for creating a new team include name of team, description of team, type of team and type of debates. In a step 1316 (FIG. 13B), it may be determined if a user seeks to join an existing team. If user seeks to join an existing team and has predetermined the team to join, then in a step 1318, user may select to join a team. In a step 1320, it may be determined if a user seeks to search for a team to join based on a set of search terms. If user seeks to search for a team using search terms, then in a step 1322 user may enter search terms for search. Then in a step 1324, user may be presented with a list of existing teams matching the search terms and if user finds a team or teams to join, then in a step 1326 user may select to join a team or multiple teams (FIG. 4). In a step 1328 (FIG. 13C), it may be determined if other entities seek to join a team or teams created by user. If there are requests to join user's team or teams, then in a step 1330 user may accept or reject applicants seeking to join a team or teams created by user (FIG. 5). In a step 1332, it may be determined if user seeks to find a debate or debates to view or join. If user is seeking to view or join a debate or debates, then in a step 1334 user may request to join or view a debate or debates. In a step 1336, it may be determined if a user seeks to create a new debate. If a user seeks to create a new debate, then in a step 1338 user may enter information for creating a new debate (FIGS. 6A-B). Non-limiting examples of information which may be entered for creating a new debate include name of debate, description of debate and type of debate. In a step 1340 (FIG. 13D), it may be determined if user seeks to search for debates to view or join. If user seeks to search for a debate to view or join, then in a step 1342 the user may enter search terms for finding a suitable debate or debates. In a step 1344, a user may be presented with a list of debates matching the search terms submitted in step 1342. If user finds a debate or debates deemed desirable to view or join, then in a step 1346 the user may request to join or view a debate or debates (FIG. 7). In a step 1348, it may be determined if an outside entity has requested to join a debate or debates created by user. An outside entity may be configured to access software via client 104 (FIG. 1), for example. If outside entities have requested to join a debate or debates created by user, then in a step 1350 the user may accept or reject debate applicants (FIG. 8). In a step 1352 (FIG. 13E), it may be determined if an outside entity has requested to view a debate or debates created by user. If an outside entity has requested to view a debate or debates created by user, then in a step 1354 the user may accept or reject applicants for viewing a debate (FIG. 9). In a step 1356, user may open a window for interface, control and operation of the portion of the debate for which the user may participate or view (FIG. 10). In a step 1358 (FIG. 13F), it may be determined if user may upload media. User may create media for upload using microphone 132 (FIG. 1) and video camera 142 (FIG. 1). If user seeks to upload media, then in a step 1360 user may enter information for uploading media (FIG. 11). In a step 1362, it may be determined if a user may listen to audio and/or view video or other media. If it is determined that user may listen to audio and/or view video, then in a step 1364 user may listen to audio and/or view video or other media as appropriate (FIG. 11). In a step 1366, it may be determined if the debate has completed. If the debate has not completed, then operation of the software may transition to step 1358. If the debate has completed, then in a step 1368 it may be determined if user may vote. If user is to vote, then in a step 1370 the user may enter a vote (FIG. 12). Operation of software may terminate in a step 1372.

In yet another embodiment of the present invention, instead of the uploaded video, live video internet broadcast, or webcast is configured and used according to techniques known to those skilled in the art.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the functions provided by clients 102 and 104, local networks 106 and 108 and by global network 110 as illustrated in FIG. 1 and the portions of the operation of the example software embodiment performed by a user as illustrated in FIG. 13A-F may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of global network interaction for performing debates according to the present invention will be apparent to those skilled in the art. The invention has been described above by way of illustration, and the specific embodiments disclosed are not intended to limit the invention to the particular forms disclosed. For example, the particular implementation of performing a globally networked debate may vary depending upon the particular type client or debate used. The clients and debates described in the foregoing were directed to conventional formal debates using conventional computing and network devices; however, similar techniques may be provided using other types of devices such as televisions and game systems. Implementations of the present invention made for devices other than conventional computing and network devices are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method executed by one or more computing processors, the method comprising:
steps for transmitting over a network, a user's request for engaging in a selected formal debate;
steps for transmitting over said network, a further request for finding opposition to engage in said selected formal debate;
steps for transmitting over said network, a selected topic for said selected formal debate;
steps for uploading over said network, at least one supporting media upload for supporting a first viewpoint of said selected topic;
steps for uploading over said network, at least one opposing media upload for rebutting said first viewpoint; and
steps for transmitting over said network, ranking results, thereby enabling users engaging in said selected formal debate to be ranked and a winner of said selected formal debate to be determined.

2. The method as recited in claim 1, further comprising steps for transmitting over said network, a further request for creating a team for engaging in said selected formal debate.

3. The method as recited in claim 2, further comprising steps for transmitting over said network, a further request for joining said team.

4. A method executed by one or more computing processors, the method comprising the steps of:
transmitting over a network, from a client application being executed by one or more user clients, a user's request for engaging in a selected formal debate, wherein said selected formal debate comprises a standardized format for engaging in debate;
transmitting over said network, from said client application being executed by one or more user clients, a further request for finding opposition to engage in said selected formal debate;
transmitting over said network, from said client application being executed by one or more user clients, a selected topic for said selected formal debate;
uploading over said network, from said client application being executed by one or more user clients, at least one supporting media upload for supporting a first viewpoint of said selected topic, where time for completing said supporting media upload being constrained to a first period of time;
uploading over said network, from said client application being executed by one or more user clients, at least one opposing media upload for rebutting said first viewpoint, where time for completing said opposing media upload being constrained to a second period of time; and
transmitting over said network, from said client application being executed by one or more user clients, ranking results from outside entities viewing said supporting media and said opposing media, where time for completing said transmitting of ranking results being constrained to a third period of time, thereby enabling users engaging in said selected formal debate to be ranked and a winner of said selected formal debate to be determined.

5. The method as recited in claim 4, further comprising the step of transmitting over said network, from said client application being executed by one or more user clients, a further request for creating a team for engaging in said selected formal debate.

6. The method as recited in claim 5, further comprising transmitting over said network, from said client application being executed by one or more user clients, a further request for joining said team.

7. The method as recited in claim 4, wherein said outside entities view said supporting media and said opposing media via one or more channels established by said users engaging in said formal debate.

8. The method as recited in claim 7, wherein said one or more channels are linkable to or sharable by social networking websites.

9. The method as recited in claim 4, wherein said first period of time comprises a fixed amount of time for researching said selected topic and preparing said supporting media.

10. The method as recited in claim 4, wherein said second period of time comprises a fixed amount of time for researching said selected topic, reviewing said supporting media and preparing said opposing media.

11. The method as recited in claim 4, wherein said third period of time comprises a fixed amount of time for reviewing said supporting media, opposing media and preparing said ranking.

12. A system comprising:
a plurality of clients, configurable for multimedia presentations, in communication with a network enabling bidirectional communication between said clients, each of said clients comprising a client application for enabling users to: issue a request for engaging in a selected formal debate, wherein said selected formal debate comprises a standardized format for engaging in debate; issue a request for finding opposition to engage in said selected formal debate; select a topic for said selected formal debate; upload at least one supporting media upload for supporting a first viewpoint of said selected topic, where time for completing said supporting media upload being constrained to a first period of time; upload at least one opposing media upload for rebutting said first viewpoint, where time for completing said opposing media upload being constrained to a second period of time; and post ranking results from outside entities viewing said supporting media and said opposing media, where time for completing said posting being constrained to a third period of time, thereby enabling users engaging in said selected formal debate to be ranked and a winner of said selected formal debate to be determined; and
a communication gateway linking said network to at least one server for at least storing media uploads and managing user registrations.

13. The system as recited in claim 12, wherein said client application further enables users to issue a request for creating a team for engaging in said formal debate.

14. The system as recited in claim 13, wherein said client application further enables users to issue a request for joining said team.

15. The system as recited in claim 12, wherein said outside entities view said supporting media and said opposing media via one or more channels established by said users engaging in said formal debate.

16. The system as recited in claim 12, wherein said first period of time comprises a fixed amount of time for researching said selected topic and preparing said supporting media.

17. The system as recited in claim 12, wherein said second period of time comprises a fixed amount of time for researching said selected topic, reviewing said supporting media and preparing said opposing media.

18. A computer program product residing on or being distributed across one or more computer readable mediums having a plurality of instructions stored thereon which, when executed by one or more associated processors, cause the one or more processors to:
transmit over a network a user's request for engaging in a selected formal debate, wherein said selected formal debate comprises a standardized format for engaging in debate;
transmit over said network a further request for finding opposition to engage in said selected formal debate;
transmit over said network a selected topic for said selected formal debate;
upload over said network at least one supporting media upload for supporting a first viewpoint of said selected topic, where time for completing said supporting media upload being constrained to a first period of time;
upload over said network at least one opposing media upload for rebutting said first viewpoint, where time for completing said opposing media upload being constrained to a second period of time; and
transmit over said network ranking results from outside entities viewing said supporting media and said opposing media, where time for completing said transmitting of ranking results being constrained to a third period of time, thereby enabling users engaging in said selected formal debate to be ranked and a winner of said selected formal debate to be determined.

19. The computer program product as recited in claim 18, further comprising instructions for transmitting over said network a further request for creating a team for engaging in said selected formal debate.

20. The computer program product as recited in claim 18, further comprising instructions for transmitting over said network a further request for joining said team.
